(19) United States
(12) Patent Application Publication
(10) Pub. No.: US 2017/0171272 A1
(43) Pub. Date: Jun. 15, 2017

(54) DISTRIBUTED IN-VEHICLE RESOURCE DOWNLOADING AND STREAMING

(71) Applicant: Myine Electronics, Inc., Ferndale, MI (US)

(72) Inventors: Scott Smereka, Warren, MI (US); Joey Ray Grover, Madison Heights, MI (US); Corey Maylone, Berkley, MI (US); John Byrne, Detroit, MI (US); Justin Dickow, Royal Oak, MI (US); Joel J. Fischer, Royal Oak, MI (US)

(21) Appl. No.: 14/966,939

(22) Filed: Dec. 11, 2015

(51) Int. Cl. H04L 29/06; H04L 29/08

(52) U.S. Cl. CPC H04L 65/60; H04L 67/12

(57) ABSTRACT

A plurality of media-sharing devices may each be in communication with one another over a local-area network of a vehicle and in communication with a server over a wide-area network. A media-sharing application may be installed to each of the media-sharing devices. The media sharing application may be programmed to cause the media-sharing devices to identify one of the media-sharing devices to be a master media-sharing device. The master media-sharing device may be programmed to identify, from the server, a portion size of a resource to be downloaded, and send download requests over the local-area network to cause each of the media-sharing devices to download a different content portion of a resource from the server over the wide-area network, each content portion of the portion size.

### TECHNICAL FIELD

Aspects of the disclosure generally relate to downloading or streaming resources using multiple mobile devices located within a vehicle.

### BACKGROUND

Vehicle occupants may wish to access resources stored to their smartphones, tablets, or other mobile devices. In other cases, the occupants may wish to access resources that are stored to a remote server. For instance, an occupant may wish to stream a movie file from a remote media server. However, such downloads may be slow, or may incur an undesirable amount of network usage to the mobile device.

### SUMMARY

In a first illustrative embodiment, a system includes a plurality of media-sharing devices, each in communication with one another over a local-area network of a vehicle and in communication with a server over a wide-area network; and a media-sharing application, installed to each of the media-sharing devices, programmed to cause the media-sharing devices to identify one of the media-sharing devices as being a master media-sharing device, the master media-sharing device programmed to identify, from the server, a content portion size of a resource to be downloaded, and send download requests over the local-area network to cause each of the media-sharing devices to download a different content portion of the resource from the server over the wide-area network, each content portion being of the content portion size.

In a second illustrative embodiment, a method includes identifying a portion size of a resource based on a total size of the resource and a count of media-sharing devices communicating with one another over a local-area network of a vehicle and with a server over a wide-area network; sending download requests over the local-area network causing the media-sharing devices to download portions of the resource over the wide-area network of the portion size; and assembling the resource from the portions.

In a third illustrative embodiment, a non-transitory computer-readable medium embodying instructions that, when executed by a processor of a media-sharing device, are configured to cause the media-sharing device to determine that the media-sharing device is a master media-sharing device; create a list of the media-sharing devices communicating with the media-sharing device over a local-area network of a vehicle and with a server over a wide-area network; receive a request for a resource to be downloaded from the server over the wide-area network; and assign portions of the resource to be downloaded to each of the media-sharing devices on the list.

### BRIEF DESCRIPTION OF THE DRAWINGS

FIG. 1 illustrates an example diagram of a system that may be used to provide telematics services to a vehicle;

FIG. 2A is an illustrative example of a system configured for connection-sharing for downloading of media content in the vehicle;

FIG. 2B illustrates an alternate example system configured for connection-sharing for downloading of media content in the vehicle;

FIG. 3 is an illustrative example of master and slave media-sharing devices;

FIGS. 4A-4D illustrates an example of operation of the media-sharing application of the master media-sharing device performing connection-sharing for downloading of an instance of media content; and

FIG. 5 illustrates an example process for playing back a selected instance of media content.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A plurality of devices may be connected to one another over a local-area network and to a server over a wide-area network. Each device may use its connection over the wide-area network to download a portion of a resource, and its connection over the local-area network to provide the downloaded portion to a local storage. The resource may accordingly be assembled by combining the portions stored to the local storage. In an example, a master device of the plurality of devices may direct the other devices which portions to download, may manage storage of the portions, and may assemble the resource once the portions are received. By using multiple devices to download the portions of the resource, the system may allow for the resource to be downloaded faster than may be otherwise accomplished using a single device connection to the server over the wide-area network. Moreover, the system may allow for the data usage required to download the resource to be spread across the connected devices.

As one example, a driver and two passengers in a vehicle may wish to stream a movie for playback. To avoid skips in playback of the movie, the amount of bandwidth required may be significant. The bandwidth of a single device connection over the wide-area network may be insufficient to stream the movie. However, if the driver and two passenger devices are used together to download the movie, then the system may take advantage of each of the three device wide-area-network connections simultaneously. One of the devices may be designated to be the master device in control of the media streaming process. In an example, the master device may be the head unit of the vehicle or a mobile device paired to the head unit as the driver device. Further aspects of the system are described in detail herein.

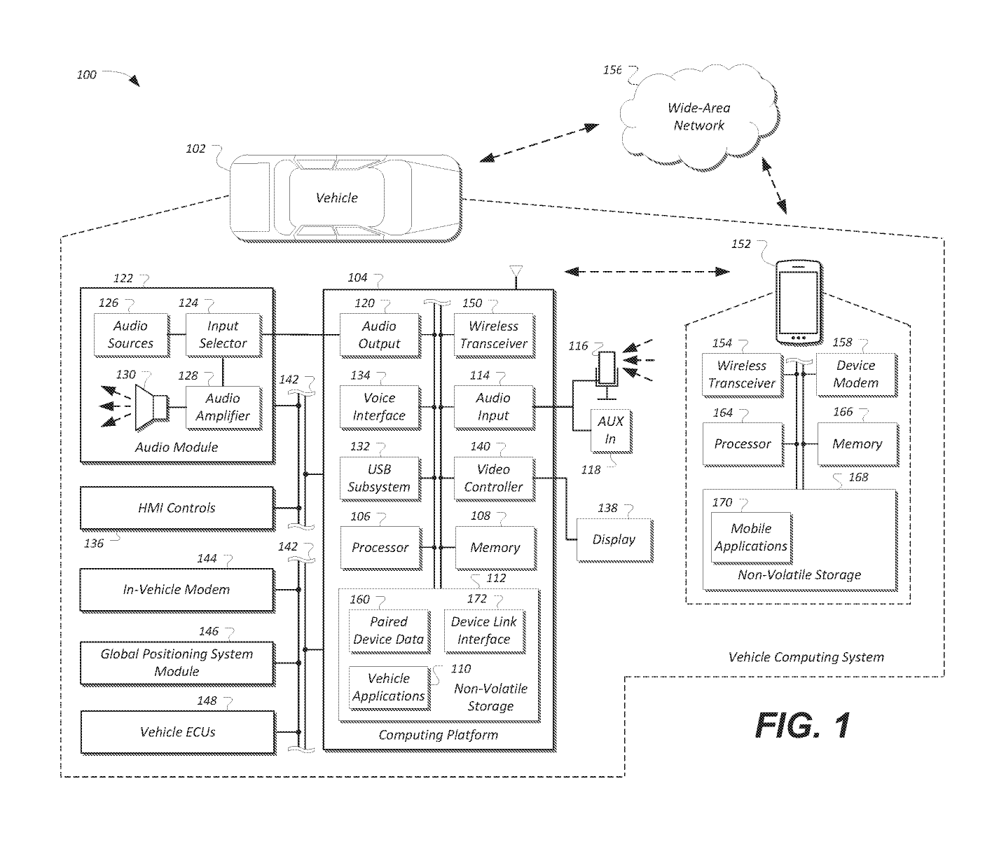

FIG. 1 illustrates an example diagram of a system 100 that may be used to provide telematics services to a vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory (e. g., tangible) medium that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a wired jack, such as a stereo input, or a wireless input, such as a BLUETOOTH audio connection. In some examples, the audio input 114 may be configure to provide audio processing capabilities, such as pre-amplification of low-level signals, and conversion of analog inputs into digital data for processing by the processor 106.

The computing platform 104 may also provide one or more audio outputs 120 to an input of the audio playback functionality of the audio module 122. In other examples, the computing platform 104 may provide audio output to the occupants through use of one or more dedicated speakers (not illustrated). The audio module 122 may include an input selector 124 configured to provide audio content from a selected audio source 126 to an audio amplifier 128 for playback through vehicle speakers 130. The audio sources 126 may include, as some examples, decoded amplitude modulated (AM) or frequency modulated (FM) radio signals, and compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a grammar of available commands, and voice prompt generation for output via the audio module 122. In some cases, the system may be configured to temporarily mute, fade, or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke computing platform 104 functions (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle data buses 142. The in-vehicle data buses 142 may include one or more of a vehicle controller area network (CAN), an Ethernet network, and a media oriented system transfer (MOST), as some examples. The in-vehicle data buses 142 may allow the computing platform 104 to communicate with other vehicle 102 systems, such as an vehicle modem 144 (which may not be present in some configurations), a global positioning system (GPS) module 146 configured to provide current vehicle 102 location and heading information, and various vehicle ECUs 148 configured to provide other types of information regarding the systems of the vehicle 102. As some non-limiting possibilities, the vehicle ECUs 148 may include a powertrain controller configured to provide control of engine operating components (e.g., idle control components, fuel delivery components, emissions control components, etc.) and monitoring of engine operating components (e.g., status of engine diagnostic codes); a body controller configured to manage various power control functions such as exterior lighting, interior lighting, keyless entry, remote start, and point of access status verification (e.g., closure status of the hood, doors and/or trunk of the vehicle 102); a radio transceiver configured to communicate with key fobs or other local vehicle 102 devices; and a climate control management controller configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle data bus 142, and the vehicle modem 144, GPS module 146, and vehicle ECUs 148 may communicate with the computing platform 104 over a second in-vehicle data bus 142. In other examples, the computing platform 104 may be connected to more or fewer in-vehicle data buses 142. Additionally or alternately, one or more HMI controls 136 or other components may be connected to the computing platform 104 via different in-vehicle data buses 142 than shown, or directly without connection to an in-vehicle data bus 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The wide-area network 156 may provide communications services, such as packet-switched network services (e.g., Internet access, VoIP communication services), to devices connected to the wide-area network 156. An example of a wide-area network 156 may include a cellular telephone network. Mobile devices 152 may provide network connectivity to the wide-area network 156 via a device modem 158 of the mobile device 152. To facilitate the communications over the wide-area network 156, mobile devices 152 may be associated with unique device identifiers (e.g., mobile device numbers (MDNs), Internet protocol (IP) addresses, mobile station international subscriber directory numbers (MSISDNs), international mobile subscriber identity (IMSI), etc.) to identify the communications of the mobile devices 152 over the wide-area network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, secret information shared between the paired device and the computing platform 104 such as link keys, and/or personal identification numbers (PINs), and most recently used or device priority information, such that the computing platform 104 may automatically reconnect to the mobile devices 152 matching data in the paired device data 160 without user intervention.

When a mobile device 152 that supports network connectivity is paired with the computing platform 104, the mobile device 152 may allow the computing platform 104 to use the network connectivity of the device modem 158 to communicate over the wide-area network 156. In one example, the computing platform 104 may utilize a data-over-voice connection over a voice call or a data connection of the mobile device 152 to communicate information between the computing platform 104 and the wide-area network 156. Additionally or alternately, the computing platform 104 may utilize the vehicle modem 144 to communicate information between the computing platform 104 and the wide-area network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 or other locally-networked devices and with the wide-area network 156.

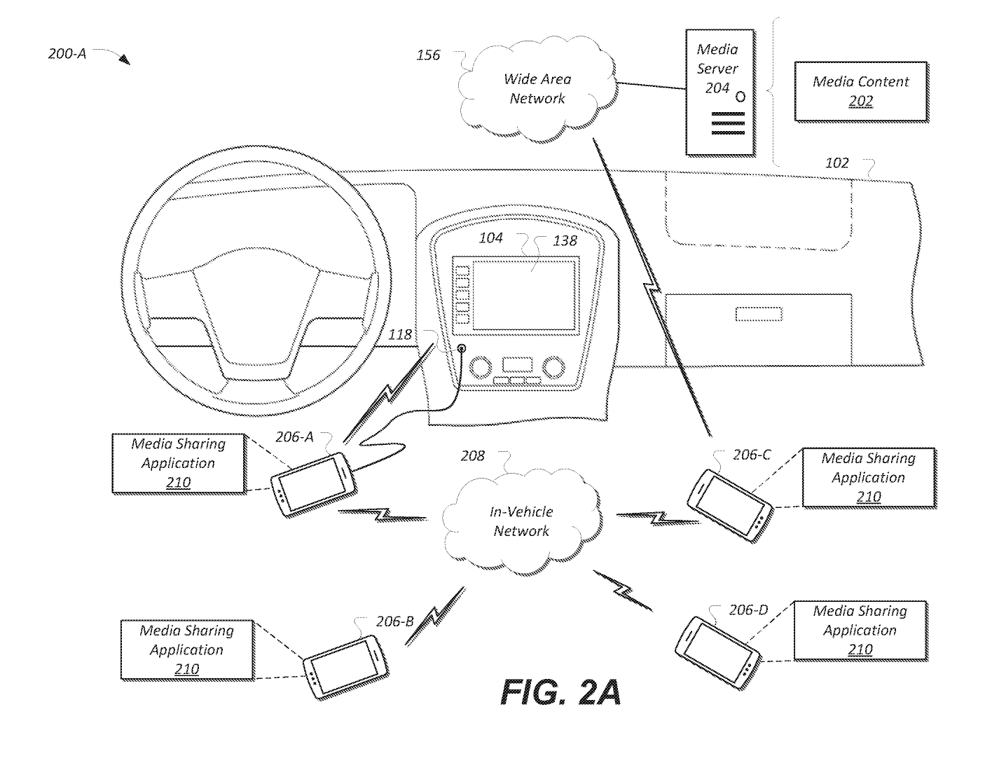

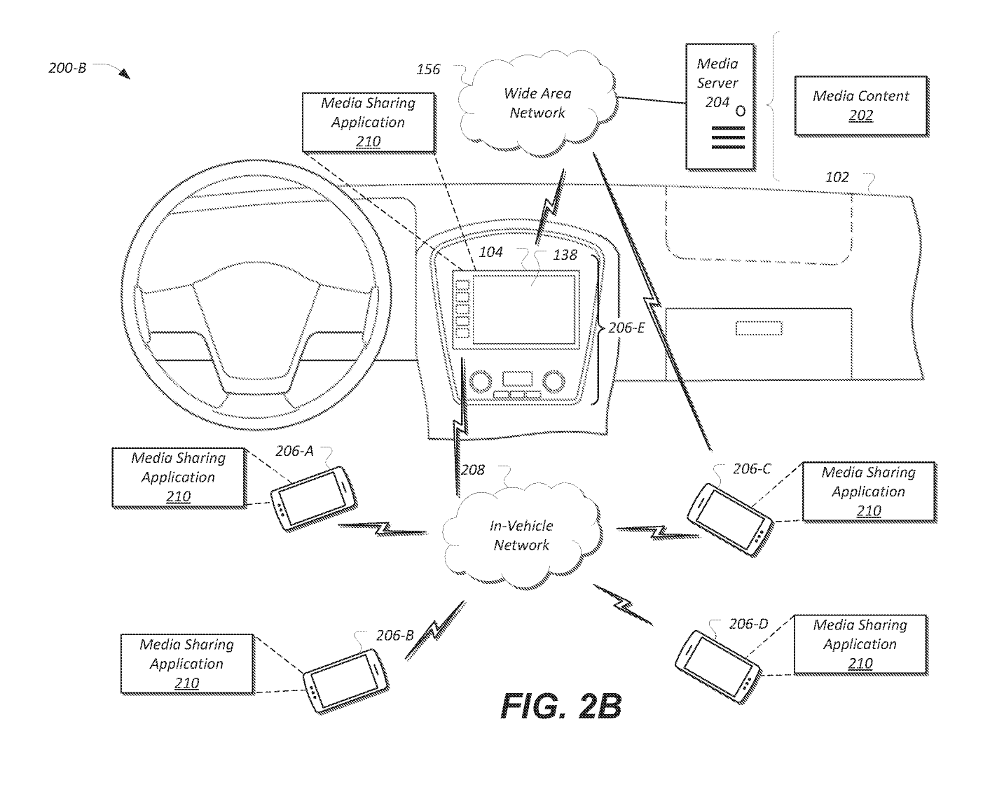

FIG. 2A is an illustrative example of a system 200-A configured for connection-sharing for downloading of media content 202 in the vehicle 102. As illustrated, the vehicle 102 include a display 138 mounted in a HMI control area between the driver and front passenger seats. The vehicle 102 also includes a plurality of networked media-sharing devices 206-A through 206-D (collectively 206) configured to communicate with one another via a local in-vehicle network 208. Each of the media-sharing devices 206 is also configured to communicate with a media server 204 over the wide-area network 156. The media server 204 may be configured to serve media content 202 to connected clients via the wide-area network 156. A media-sharing application 210 may be installed to the storage mediums 168 of each of the media-sharing devices 206, and may be configured to facilitate connection-sharing for downloading the media content 202 for playback within the vehicle 102. It should be noted that this configuration is merely an example, and systems having more or fewer media-sharing devices 206 or varied device layouts are possible.

Media content 202 may include, for example, music, television, movies, commercials, or other types of content. In some examples, the media content 202 may include video and audio components, but in some cases an instance of media content 202 may include only audio or only video. To facilitate the identification of the media content 202, instances of media content 202 may further include or otherwise be associated with metadata information, such as name, artist, title, track number, duration, rating, date recorded, or unique identifier, as some non-limiting examples.

The media server 204 may be configured to maintain instances of media content 202 for download and/or streaming to clients. The media server 204 may, for example, include or be configured to access one or more data stores on which instances of media content 202 are maintained. As one possibility, the instances of media content 202 may be indexed in one or more data stores for retrieval according to metadata of the media content 202.

The media server 204 may be configured to receive requests for instances of media content 202, such as a request indicating a desired instance of media content 202 by metadata information. Responsive to the request, the media server 204 may send the requested instance of media content 202 to the requesting client. As explained in more detail below, the media server 204 may be configured to service requests for portions of instances of media content 202. As an example, the media server 204 may be configured to service client requests for ranges of bytes of an instance of media content 202 to be downloaded.

The media-sharing devices 206 may include various types of computing devices (e.g., tablet computing devices, smartphones, etc.) having capabilities including local-area networking, wide-area networking, processing, and in some cases data storage. In an example, the media-sharing devices 206 may include mobile devices 152 brought into the vehicle 102 by occupants of the vehicle 102. In another example discussed below, the media-sharing devices 206 may also include the computing platform 104. The media-sharing devices 206 may be configured to store media content 202 for playback (e.g., in the non-volatile storage 168 of the mobile devices 152), or in one or more other memories of the media-sharing devices 206. In an example, a media-sharing device 206 may request media content 202 from the media server 204, and may store the media content 202 to the media-sharing device 206 for playback. In another example, the media content 202 may be streamed to the media-sharing device 206 from the media server 204, and may be played back as it is retrieved, with or without being saved to storage.

The in-vehicle network 208 may include a network local to or within the vehicle 102 over which the media-sharing devices 206 communicate media content 202 or other information. In one non-limiting example, the local in-vehicle network 208 may include a wireless local-area network or Wi-Fi network operating in accordance with the IEEE 802.11 specification.

The media-sharing application 210 may be installed to the media-sharing devices 206, and may be configured to allow the media-sharing devices 206 to perform connection-sharing for the downloading of media content 202 from the media server 204 for playback to the vehicle 102. The connection-sharing may include determining which of the media-sharing devices 206 is to be the master media-sharing devices 206 controlling the connection-sharing, determining where to store the media content 202 to be downloaded, identifying other media-sharing devices 206 on the in-vehicle network 208 available to aid in downloading the media content 202 over the wide-area network 156 from the media server 204, and managing which portions of the media content 202 are to be downloaded by which of the identified media-sharing devices 206. By using multiple media-sharing devices 206 to download the media content 202, the media content 202 may be downloaded faster than may be otherwise accomplished using a single media-sharing device 206 connection to the media server 204 over the wide-area network 156.

FIG. 2B illustrates an alternate example system 200-B configured for connection-sharing for downloading of media content 202 in the vehicle 102. In the alternate example 200-B, the computing platform 104 of the vehicle 102 may also execute the media-sharing application 210 and communicate with the media-sharing devices 206 over the in-vehicle network 208. Thus, the computing platform 104 of the vehicle 102 may additionally serve as one of the media-sharing devices 206.

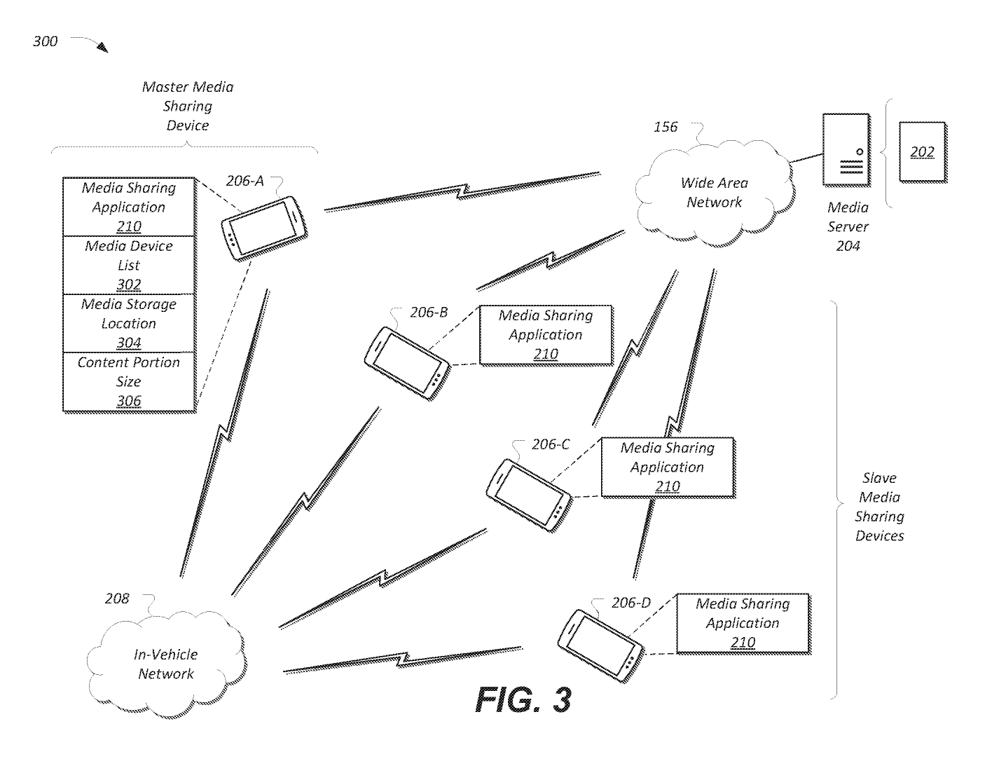

Referring to FIG. 3, the media-sharing application 210 may be executed by the media-sharing devices 206 to determine which of the media-sharing devices 206 is to be the master media-sharing device 206 controlling the connection sharing. The master media-sharing device 206 may be configured to perform certain management operations in support of the connection sharing. As an example, the master media-sharing device 206 may be tasked with identifying the other media-sharing devices 206 on the in-vehicle network 208 to create a media device list 302 of available media-sharing devices 206 to aid in downloading the media content 202. The master media-sharing device 206 may also update the media device list 302 of available media-sharing devices 206 based on changes to connected devices on the in-vehicle network 208. As an example, the master media-sharing device 206 may determine a media storage location 304 to which to store the media content 202 that is being downloaded. As yet another example, the master media-sharing device 206 may manage the downloading of the media content 202 from the media server 204 using the identified mobile devices 152, including determining a content portion size 306 for the downloading of portions of the media content 202 as well as managing storage and/or assembly of the downloaded portions to the media storage location 304.

With respect to identifying which of the media-sharing devices 206 is the master media-sharing device 206, the media-sharing application 210 may designate one of the media-sharing devices 206 to be the master media-sharing device 206. In an example, the media-sharing application 210 may determine the master media-sharing device 206 to be the one of the media-sharing device 206 that is paired with the computing platform 104. For some computing platforms 104, multiple media-sharing devices 206 may simultaneously be paired with the computing platform 104. In such examples, the media-sharing application 210 may determine the master media-sharing device 206 to be the device that is paired with the computing platform 104 as the driver or primary device. As another possibility, the media-sharing application 210 may determine the master media-sharing device 206 to be the device paired with the computing platform 104 with the highest pairing priority.

As yet a further possibility, the media-sharing application 210 may determine the master media-sharing device 206 by prompting the users to identify which of the media-sharing devices 206 is the master media-sharing device 206. For instance, each media-sharing device 206 may display a prompt asking whether the device displaying the prompt should be the master media-sharing device 206, and the first media-sharing device 206 to receive acknowledgement form a user may become the master media-sharing device 206. As some even further possibilities, the media-sharing application 210 may choose which device is the master media-sharing device 206 at random, or the media-sharing application 210 may choose the master media-sharing device 206 to be the one of the media-sharing devices 206 with the most resources (e.g., fastest processor, most available processor time, most available memory, most available storage capacity, etc.).

To allow the media-sharing applications 210 executed by the media-sharing device 206 to make the determination of which device is master, the media-sharing applications 210 may be programmed to cause the media-sharing devices 206 to send device identifiers and corresponding statistics regarding the resources, pairing status, user input, etc. of the media-sharing devices 206 on which they are executed to one another over the in-vehicle network 208.

A media-sharing application 210 that determines it is executed by the master media-sharing device 206 may send a message to the other media-sharing applications 210 informing them which of the media-sharing devices 206 in the master media-sharing device 206. In an example, the message may include an address or other indication to the other media-sharing devices 206 of which of the master media-sharing devices 206 is the master media-sharing device 206. The media-sharing applications 210 executed by the media-sharing devices 206 receiving the message may accordingly allow the master media-sharing devices 206 to control shared downloading by the receiving media-sharing devices 206. The other media-sharing devices 206 that are not the master device may be referred to as slave media-sharing devices 206.

The media device list 302 may include a listing of addresses, capabilities, or other information or identifiers of the slave media-sharing devices 206 available to the master media-sharing device 206 over the in-vehicle network 208. In an example, the media-sharing application 210 of the master media-sharing device 206 may maintain the media device list 302 on storage of the master media-sharing device 206. To create the media device list 302, in an example, the media-sharing application 210 of the master media-sharing device 206 may send a request over the in-vehicle network 208 to other media-sharing devices 206, and may add addresses or other identifiers of any responding media-sharing devices 206 to the device list.

In some examples, the messaging to determine the devices to add to the media device list 302 may be done in combination with the determination of which device is the master media-sharing device 206. For instance, each media-sharing device 206 may inform each other media-sharing device 206 of its information (e.g., resources, pairing status, whether it was user designated as master, etc.), and the media-sharing device 206 meeting the criteria used for master status may designate itself to be the master media-sharing device 206 and may also generate the media device list 302 based on the information received from the other media-sharing devices 206.

It should be noted that the requests or other messaging to determine the master media-sharing device 206 and/or devices of the media device list 302 may be performed over the in-vehicle network 208, or over other mediums or networks than the in-vehicle network 208. As some other possibilities, the requests for other media-sharing devices 206 may be sent over Bluetooth, Bluetooth Low Energy (BLE), or another wired or wireless network over which the media-sharing devices 206 may communicate.

The media-sharing application 210 of the master media-sharing device 206 may also update the media device list 302 to ensure that it includes a current listing of slave media-sharing devices 206. As one possibility, the media-sharing application 210 of the master media-sharing device 206 may periodically poll the devices currently on the media device list 302 to ensure that they are still available for use. As another possibility, the media-sharing application 210 of the master media-sharing device 206 may periodically broadcast requests querying for media-sharing devices 206, and may update the media device list 302 to add devices newly responding to the requests or remove devices that no longer responding to the requests.

The media storage location 304 may be memory or other storage on one or more of the devices of the system on which the media content 202 is stored. In many cases, the media-sharing application 210 of the master media-sharing device 206 may utilize the local storage of the master media-sharing device 206 as the media storage location 304. In other cases, however, the media-sharing application 210 of the master media-sharing device 206 may utilize another storage of the system, such as the storage of the media-sharing device 206 having the most available storage space (e.g., as indicated in the media device list 302 information), a storage of the media-sharing device 206 that is the computing platform 104, etc.

The master media-sharing device 206 may receive a request to download an instance of media content 202 for playback. In an example, a user may use a user interface of the computing platform 104 provided on the display 138 to select an instance of media content 202 to be downloaded. In another example, a user may use a user interface of the one of the media-sharing devices 206 to select an instance of media content 202 to be downloaded. In yet a further example, a music application executed by one of the media-sharing devices 206 may request an instance of media content 202 to be downloaded or streamed for playback.

Responsive to receiving the request, the master media-sharing device 206 may prepare to download the instance of media content 202 using the available media-sharing devices 206. In an example, the media-sharing application 210 of the master media-sharing device 206 may send an information request the media server 204 to provide information regarding the requested media content 202. The information request may reference the media content 202 by metadata, such as name or unique identifier. The media server 204 may provide, responsive to the information request, data useful for managing the shared download of the instance of media content 202, such as a resource size of the media content 202 (e.g., in bytes or kilobytes) and/or a content portion size 306 of portions of the media content 202 (e.g., in bytes or kilobytes) that may be downloaded.

In some examples, the media server 204 may not specify a content portion size 306. Accordingly, the media-sharing application 210 of the master media-sharing device 206 may formulate a content portion size 306 based on the count of available media-sharing devices 206. The count of available media-sharing devices 206 may be identified according to the number of entries of the media device list 302. As one possibility, for a media content 202 instance of size S with N available devices the content portion size 306 may be set to S/N such that each device is requested to download one of the portions of the instance of media content 202. As another possibility, for N available devices the content portion size 306 may be set to S/(N*M), where M is a number of portions for each device to download (e.g., two, three, five, ten, etc.).

In yet further examples, the content portion size 306 and resource size may be unknown. In such examples, the media-sharing application 210 of the master media-sharing device 206 may choose a default portion size (e.g., 128 kilobytes, 1 megabyte, etc.).

With the media device list 302, media storage location 304, and content portion size 306 determined, the media-sharing application 210 of the master media-sharing device 206 may begin to direct the media-sharing devices 206 to download the instance of media content 202 from the media server 204.

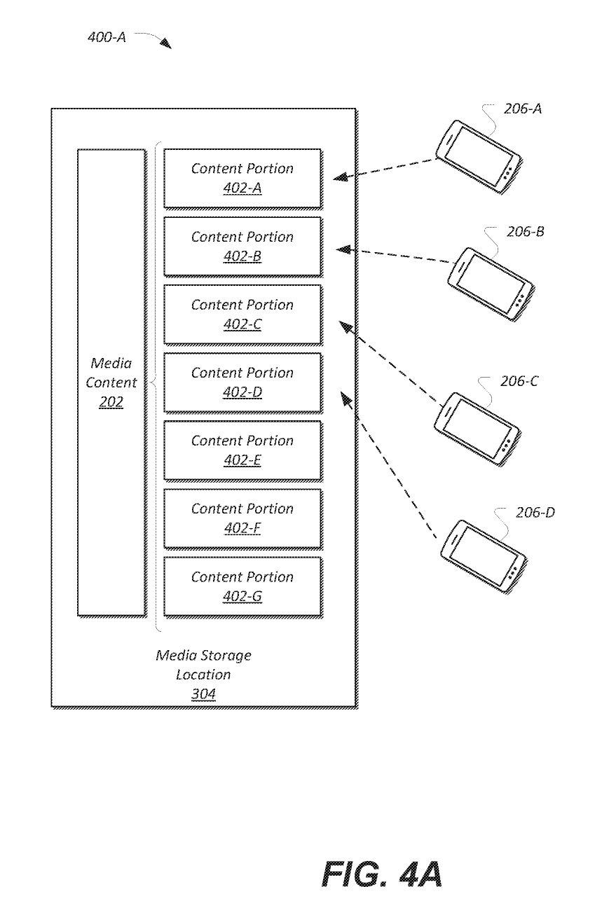

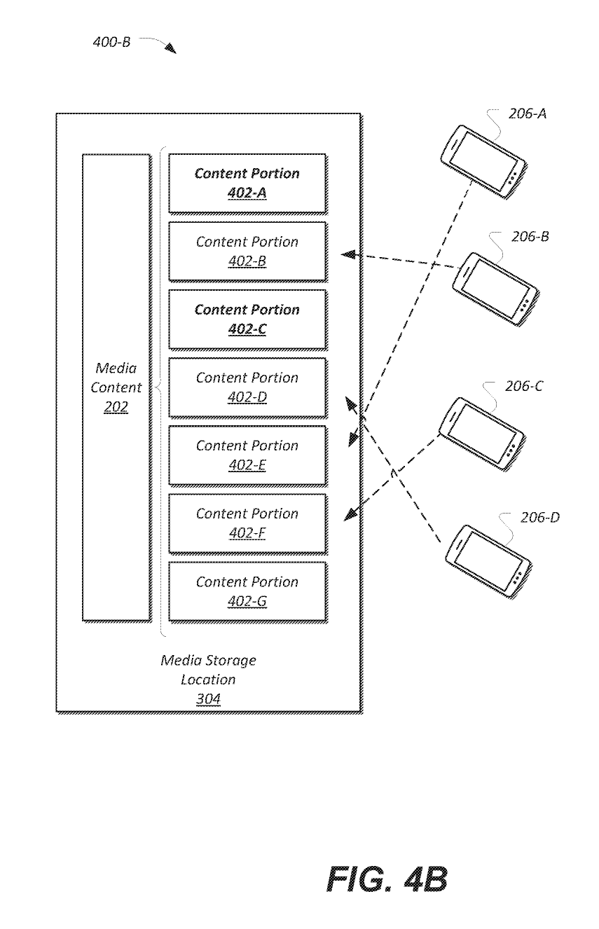

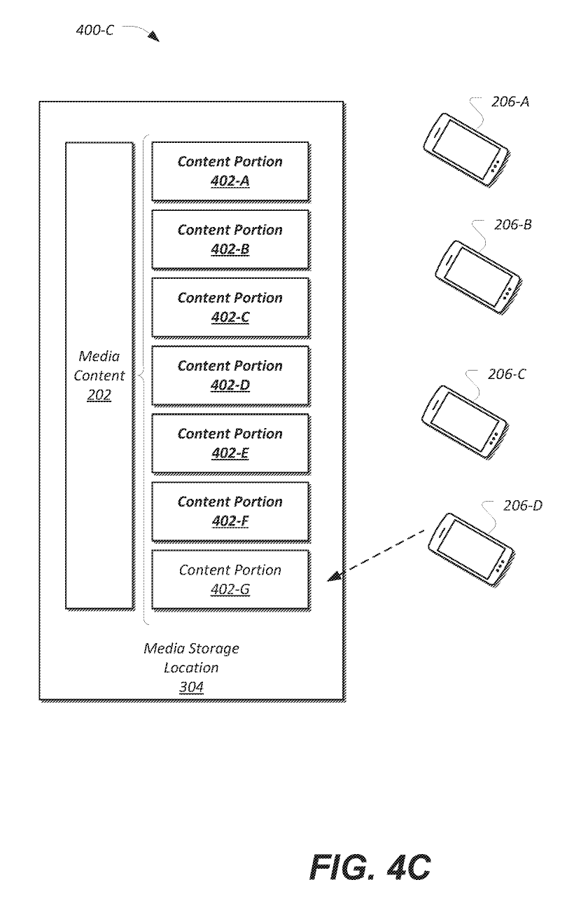

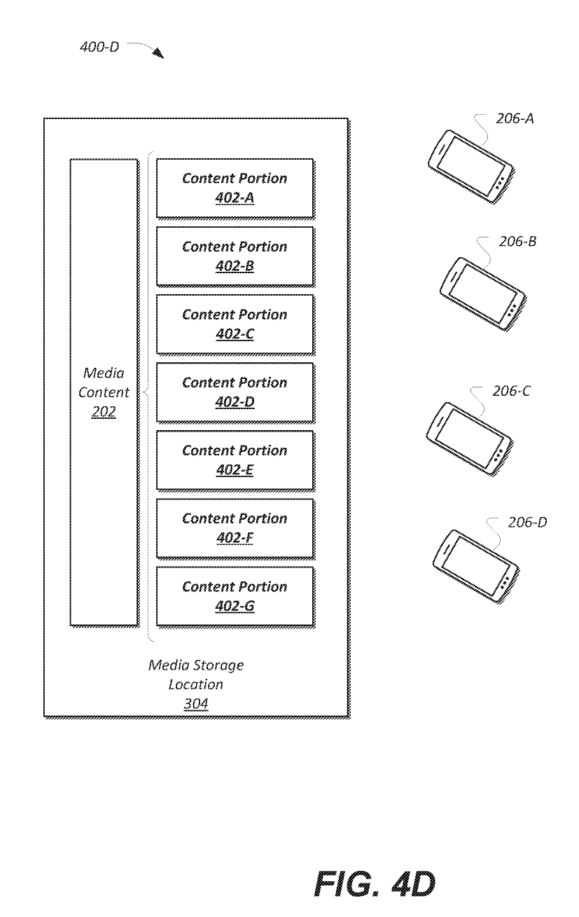

FIGS. 4A-4D illustrates an example 400 of operation of the media-sharing application 210 of the master media-sharing device 206-A performing connection-sharing for downloading of an instance of media content 202. More specifically, each of the examples 400-A through 400-D illustrate a state of the download of content portions 402 of an instance of media content 202 from the media server 204 to a media storage location 304. In the example 400, the media-sharing application 210 of the master media-sharing device 206-A is configured to manage the download of the media content 202 using four media-sharing devices 206, i.e., media-sharing devices 206-A, 206-B, 206-C, and 206-D.

In the illustrated example 400, the content portion size 306 is such that the media content 202 is divided into seven content portions 402. For instance, the media content 202 file may be seven megabytes and the content portion size 306 may be one megabyte. Or as another possibility, the media content 202 file may be ten megabytes and the content portion size 306 may be one and a half megabytes (e.g., the final content portion 402-G is of lesser length).

The media-sharing application 210 of the master media-sharing device 206 may command the slave media-sharing devices 206 to download content portions 402 of the media content 202. In an example, the media-sharing application 210 of the master media-sharing device 206 may issue download requests to the slave media-sharing devices 206 over the in-vehicle network 208. The download requests may be addressed to the media-sharing device 206 being requested to perform a download, and may include information to allow for the receiving media-sharing device 206 to perform the download.

For instance, the download requests may include a location of the media server 204 from which the media content 202 is to be downloaded. As some possibilities, the location may be specified in the download requests as an address, (e.g., a universal resource locator (URL), an IP address and path, etc.). As some other possibilities, the resource location may be specified as a name or identifier of a web service and a name or identifier of the media content 202. In some examples, the media server 204 may require credentials or account information, and the download requests may further provide the additional credential or account information required to access the media server 204.

The download request may also include an indication of which content portion 402 to be downloaded by the receiving media-sharing device 206. For instance, the download request may include the content portion size 306 and the content portion number to be downloaded. Or, the download request may include a data offset (e.g., a byte offset) and a data length to be downloaded from the offset (e.g., a number of bytes). Accordingly, using the information from the download request, the receiving media-sharing device 206 may formulate a download request to the media server 204 indicating the content portion 402 to download.

The media-sharing device 206 may send the downloaded content portion 402 to the originator of the download request. For example, responsive to completing the download, the media-sharing device 206 may send the complete content portion 402 to the master media-sharing device 206 over the in-vehicle network 208. In other examples, the download requests may specify the media storage location 304 for the downloaded content portion 402, and the media-sharing device 206 may download the content portion 402 to the media storage location 304. In some cases, the media-sharing device 206 may send the downloaded data to the media storage location 304 as the download progresses, rather than waiting for completion of the download of the content portion 402. Upon completion of a download, the media-sharing device 206 may send a notification to the master media-sharing device 206 indicating that the content portion 402 has been retrieved.

Accordingly, the media-sharing application 210 may use the multiple connections of the media-sharing device 206 to the wide-area network 156 to download the content portions 402, such that the media content 202 may be assembled by combining the content portions 402.

FIG. 4A illustrates an example 400-A of operation of the media-sharing application 210 before any of the content portions 402 have been downloaded to the media storage location 304. As shown, the media-sharing application 210 of the master media-sharing device 206 is directing itself to download the content portion 402-A, is directing the slave media-sharing device 206-B to download the content portion 402-B, is directing the slave media-sharing device 206-C to download the content portion 402-C, and is directing the slave media-sharing device 206-D to download the content portion 402-D.

To perform the directing, the media-sharing application 210 of the master media-sharing device 206 may send download requests over the in-vehicle network 208 to the slave media-sharing device 206-B, 206-C and 206-D. The media-sharing application 210 of the master media-sharing device 206 may also send itself a download request to command itself, but in other implementations may direct itself to perform the download directly, without sending a download request over the in-vehicle network 208.

FIG. 4B illustrates an example 400-B of operation of the media-sharing application 210 after the content portions 402-A and 402-C have been downloaded to the media storage location 304. As shown, the media-sharing device 206-A completed download of the content portion 402-A, and the media-sharing device 206-C completed download of the content portion 402-C (indicated in boldface in the illustration). Accordingly, as the media-sharing devices 206-A and 206-C are available to download additional content portions 402, and as additional content portions 402 remain to be downloaded, the media-sharing application 210 of the master media-sharing device 206 may further request the media-sharing devices 206-A and 206-C to download additional content portions 402. As shown, the media-sharing application 210 of the master media-sharing device 206 directs the media-sharing device 206-A to download the content portion 402-E, and directs the media-sharing device 206-C to download the content portion 402-F.

FIG. 4C illustrates an example 400-C of operation of the media-sharing application 210 after the content portions 402-A through 402-F have been downloaded to the media storage location 304. Thus, in the example 400-C, the media-sharing device 206-A has also downloaded the content portion 402-E, the media-sharing device 206-B has downloaded the content portion 402-B, the media-sharing device 206-C has also downloaded the content portion 402-F, and the media-sharing device 206-D has downloaded the content portion 402-D. Thus, only the content portion 402-G remains for download. As shown, the media-sharing application 210 of the master media-sharing device 206 directs the media-sharing device 206-D to download the remaining content portion 402-G.

FIG. 4D illustrates an example 400-D of operation of the media-sharing application 210 after all the content portions 402-A through 402-G have been downloaded to the media storage location 304. Thus, in the example 400-D, the media-sharing device 206-D has also downloaded the content portion 402-G. Once downloaded, the content portions 402 may be assembled into the media content 202, and the media content 202 may be available for use. For example, once downloaded, the paired media-sharing device 206 (or primary paired media-sharing device 206-D) may play the assembled media content 202 through the audio and/or video features of the computing platform 104.

It should be noted that in the example 400, the assignment of particular content portions 402 for download is merely one possibility, and different assignments of media-sharing devices 206 to content portions 402 may be used. The media-sharing application 210 may be configured to distribute the downloading of the content portions 402 according to various criteria. In an example, the media-sharing application 210 may be configured to perform the download assignments in an attempt to spread the data usage required in downloading the media content 202 equally across the media-sharing devices 206. In another example, the media-sharing application 210 may be configured to perform the download assignments in an attempt to speed up the download by providing further assignments to those media-sharing devices 206 that complete their assigned downloads quickest.

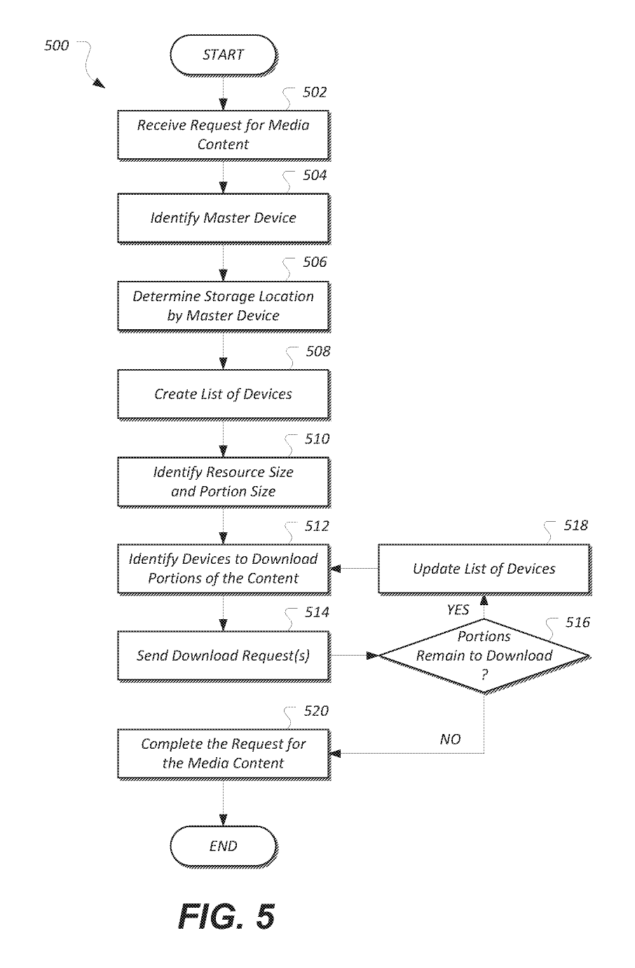

FIG. 5 illustrates an example process 500 for connection-sharing for downloading media content 202. In an example, the process 500 may be performed by media-sharing devices 206 in communication with one another over an in-vehicle network 208 and with a media server 204 over a wide-area network 156, where the media server 204 supports portioned downloading of media content 202 to the media-sharing devices 206.

At operation 502, the media-sharing devices 206 receive a request for media content 202. In an example, a user may select an instance of media content 202 to be downloaded and played from a user interface of a computing platform 104 or of a mobile device 152. In another example, a streaming music application may choose an instance of media content 202 to be downloaded or streamed for playback.

At 504, the media-sharing devices 206 identify which of the media-sharing devices 206 is the master media-sharing device 206. As some examples, the media-sharing applications 210 may determine the master media-sharing device 206 to be the one of the media-sharing device 206 that is paired with the computing platform 104 or the one paired as the primary device. As some further examples, the media-sharing applications 210 may assign the master media-sharing device 206 randomly, responsive to user input of which device is to be master, or based on a determination by the media-sharing applications 210 of which device has the most or most available resources.

At operation 506, the master media-sharing device 206 determines the media storage location 304. As some examples, the master media-sharing device 206 may designate its storage to be the media storage location 304, or the media-sharing device 206 that is the computing platform 104 to be the media storage location 304, or the media-sharing device 206 with the most available storage to be the media storage location 304.

At 508, the master media-sharing device 206 creates the media device list 302. In an example, the media device list 302 may include entries for each of the media-sharing devices 206 available to download content portions 402 of the media content 202. In an example, each entry may include at least an address of the media-sharing device 206 on the in-vehicle network 208.

At operation 510, the master media-sharing device 206 identifies the resource size and content portion size 306. In an example, the master media-sharing device 206 may request and receive the resource size and content portion size 306 from the media server 204 hosting the media content 202 to be downloaded. In another example, the master media-sharing device 206 may receive the resource size from the media server 204 and may compute the content portion size 306 based on the number of media-sharing devices 206 on the media device list 302. In yet a further example, the master media-sharing device 206 may choose a default content portion size 306 if the resource size is unavailable.

In 512, the master media-sharing device 206 identifies media-sharing devices 206 to download content portions 402 of the media content 202. In an example, the master media-sharing device 206 may assign each of the media-sharing devices 206 not currently downloading a content portion 402 with a content portion 402 of the media content 202 to be downloaded. The master media-sharing device 206 may also account for other criteria when assigning the content portions 402, such as to spread the data usage across the media-sharing devices 206 or to prefer devices having faster connections over the wide-area network 156.

At operation 514, the master media-sharing device 206 sends download requests to the media-sharing devices 206 of the media device list 302. In an example, the master media-sharing device 206 sends the download requests over the in-vehicle network 208 to the media-sharing devices 206.

At 516, the master media-sharing device 206 determines whether there are more content portions 402 remaining to download. In an example, the media-sharing devices 206 may notify the master media-sharing device 206 once they have completed downloading of their assigned content portions 402. In another example, the master media-sharing device 206 may monitor the media storage location 304 to determine which content portions 402 have been downloaded and/or to determine which content portions 402 remain to be downloaded. If the master media-sharing device 206 determines that more content portions 402 remain to be downloaded, control passes to operation 518. Otherwise, control passes to operation 520.

At operation 518, the master media-sharing device 206 updates the media device list 302. As one possibility, the media-sharing application 210 of the master media-sharing device 206 may periodically poll the devices currently on the media device list 302 to ensure that they are still available for use. As another possibility, the media-sharing application 210 of the master media-sharing device 206 may periodically broadcast requests querying for media-sharing devices 206, and may update the media device list 302 to add devices newly responding to the requests or remove devices that no longer responding to the requests. In other examples, the operation 518 may be optional, and control may pass from operation 516 to operation 512. After operating 518, control passes to operation 512.

At operation 520, the master media-sharing device 206 indicates that the download has been completed. In an example, the media content 202 may be assembled by combining the content portions 402, and may be indicated as being available for playback or other use. After operation 520, the process 500 ends.

Computing devices described herein, such as the computing platform 104, mobile devices 152, and media-sharing device 206, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a plurality of media-sharing devices, each in communication with one another over a local-area network of a vehicle and in communication with a server over a wide-area network; and
a media-sharing application, installed to each of the media-sharing devices, programmed to cause the media-sharing devices to identify one of the media-sharing devices as being a master media-sharing device, the master media-sharing device programmed to
identify, from the server, a content portion size of a resource to be downloaded, and
send download requests over the local-area network to cause each of the media-sharing devices to download a different content portion of the resource from the server over the wide-area network, each content portion being of the content portion size.

2. The system of claim 1, wherein to identify one of the media-sharing devices to be the master media-sharing device includes to determine the master media-sharing device as being the one of the media-sharing devices that is paired with a computing platform of the vehicle.

3. The system of claim 1, wherein one of the plurality of media-sharing devices is a computing platform of the vehicle.

4. The system of claim 3, wherein to identify one of the media-sharing devices to be the master media-sharing device includes to determine the master media-sharing device as being the computing platform of the vehicle.

5. The system of claim 1, wherein the master media-sharing device is further programmed to:
create a media device list of the media-sharing devices; and
select the different content portion of the resource to be downloaded by each of the media-sharing devices on the media device list.

6. The system of claim 5, wherein the master media-sharing device is further programmed to:
periodically broadcast requests querying for media-sharing devices; and
update the media device list to at least one of add a newly-responding media-sharing device to the media device list or remove a media-sharing device no longer responding to the requests from the media device list.

7. A method comprising:
identifying a portion size of a resource based on a total size of the resource and a count of media-sharing devices communicating with one another over a local-area network of a vehicle and with a server over a wide-area network;
sending download requests over the local-area network causing the media-sharing devices to download portions of the resource over the wide-area network; and
assembling the resource from the portions.

8. The method of claim 7, further comprising:
receiving a request for the resource; and
providing the resource, as assembled, responsive to the request.

9. The method of claim 7, further comprising requesting the portion size from the server.

10. The method of claim 7, further comprising:
creating a list of the media-sharing devices; and
assigning the portions of the resource to be downloaded by each of the media-sharing devices on the media device list.

11. The method of claim 10, further comprising:
periodically broadcasting requests querying for media-sharing devices; and
updating a media device list to at least one of add a newly-responding media-sharing device to the media device list or remove a media-sharing device from the media device list that is no longer responding to the requests.

12. The method of claim 10, further comprising:
assigning a first portion of the resource to be downloaded by one of the media-sharing devices; and
assigning a second portion of the resource to be downloaded by the one of the media-sharing devices responsive to receiving a notification from the one of the media-sharing devices that the first portion of the resource is downloaded.

13. The method of claim 10, further comprising assigning the portions of the resource to be downloaded by each of the media-sharing devices on the media device list to spread data usage of the wide-area network across the media-sharing devices.

14. The method of claim 7, further comprising identifying one of the media-sharing devices to be a master media-sharing device sending the download requests by determining the master media-sharing device to be the one of the media-sharing devices that is paired with a computing platform of the vehicle.

15. The method of claim 7, wherein one of the media-sharing devices is a computing platform of the vehicle.

16. The method of claim 15, further comprising identifying one of the media-sharing devices to be a master media-sharing device by determining the master media-sharing device to be the computing platform of the vehicle.

17. A non-transitory computer-readable medium embodying instructions that, when executed by a processor of a media-sharing device, are configured to cause the media-sharing device to:
determine that the media-sharing device is a master media-sharing device;
create a list of the media-sharing devices communicating with the media-sharing device over a local-area network of a vehicle and with a server over a wide-area network;
receive a request for a resource to be downloaded from the server over the wide-area network; and
assign portions of the resource to be downloaded to each of the media-sharing devices on the list.

18. The medium of claim 17, further embodying instructions to cause the media-sharing device to determine either: that the media-sharing device is the master media-sharing device responsive to identifying the media-sharing device as being a computing platform of the vehicle, or that the media-sharing device is the master media-sharing device responsive to identifying the media-sharing devices as being paired with the computing platform of the vehicle.

19. The medium of claim 17, wherein the resource is an instance of media content hosted by the server.

20. The medium of claim 17, further embodying instructions to cause the media-sharing device to assemble the resource from the portions.
